(19) United States
(12) Patent Application Publication
(10) Pub. No.: US 2015/0053009 A1
(43) Pub. Date: Feb. 26, 2015

(54) ULTRASONIC GUIDED WAVE CORROSION DETECTION AND MONITORING SYSTEM AND METHOD FOR STORAGE TANK FLOORS AND OTHER LARGE-SCALE, COMPLEX, PLATE-LIKE STRUCTURES

(71) Applicant: FBS, INC., State College, PA (US)

(72) Inventors: Fei Yan, Sewickly, PA (US); Cody Borigo, Pennsylvania Furnace, PA (US); Steven E. Owens, Bellefonte, PA (US); Joseph L. Rose, State College, PA (US)

(21) Appl. No.: 14/466,657

(22) Filed: Aug. 22, 2014

Related U.S. Application Data
(60) Provisional application No. 61/869,412, filed on Aug. 23, 2013.

(51) Int. Cl. G01N 29/07; G01N 29/44; G01N 17/00

(52) U.S. Cl. CPC G01N 29/07; G01N 17/00; G01N 29/44; G01N 29/4445; G01N 2291/023; G01N 2291/0289; G01N 2291/105
USPC 73/598

(57) ABSTRACT

A system for defect detection in plate like structures is disclosed. The system comprises a plurality of transducers configured to be coupled to a periphery of complex-plate structure. A controller is electrically coupled to the plurality of transducers. The controller includes a machine readable storage medium and a processor in signal communication with the machine readable storage medium. The processor is configured to generate a plurality of guided wave signals using a first set of the plurality of transducers, receive the plurality of guided wave signals at a second set of the plurality of transducers, and generate tomographic pseudo-image of structural changes of the complex-plate structure based on the plurality of guided wave signals received at the second set of the plurality of transducers.

### CROSS-REFERENCE TO RELATED APPLICATIONS

This application claims priority to U.S. Provisional Patent Application No. 61/869,412, filed Aug. 23, 2013, the entirety of which is herein incorporated by reference.

### FIELD OF DISCLOSURE

The disclosure relates to the use of ultrasonic guided wave transducer array system and methods for the non-destructive inspection and structural health monitoring of storage tank floors and other large-scale, complex, plate-like structures including, but not limited to, pressure vessels, ship hulls, and aircraft structures.

### BACKGROUND INFORMATION

Large-scale storage tanks have been widely used in the refinery industry for storing crude oil or refinery products. Due to the corrosive nature of the materials stored in the storage tanks, over time, corrosion damage is generated in the tank floors. Severe corrosion damage may lead to tank leakage. Several proposed solutions exist for inspecting such a structure internally, such as visual inspection, manual UT measurements, and a Hall-effect crawler system. However, these conventional systems require emptying the tank contents and thus can only be utilized periodically and at great expense.

### SUMMARY

In various embodiments, an ultrasonic guided wave tomography system that can be used to generate imaging results for corrosion detection and monitoring in storage tank floors and similar structures is disclosed. Various embodiments of the guided wave transducer design, data acquisition, signal processing, feature extraction, and imaging algorithms of the system are disclosed herein. Application of this system and method to other large-scale, complex, plate-like structures, including but not limited to pressure vessels, ship hulls, and aircraft structures, is also possible, and within the scope of the attached claims.

### BRIEF DESCRIPTION OF THE DRAWINGS

FIG. 1A illustrates one example of a non-destructive inspection system in accordance with some embodiments.

FIG. 1B is one example of a block diagram of a controller of the non-destructive inspection system illustrated in FIGS. 1A and 1B in accordance with some embodiments.

FIG. 2 illustrates one embodiment of a piezoelectric disk transducer for tank floor monitoring.

FIG. 3 illustrates one embodiment of a circumferentially poled piezoelectric ring transducer for tank floor monitoring.

FIG. 4 illustrates one embodiment of a magnetostrictive transducer for tank floor monitoring.

FIG. 5 illustrates one embodiment of an transducer packaging scheme.

FIG. 6 illustrates another embodiment of an transducer packaging scheme.

FIG. 7 illustrates one embodiment of a resistor for dissipating static voltage across the electrodes of a large piezoelectric actuator.

FIG. 8 illustrates one embodiment of transducers installed on the annular ring outside the tank wall.

FIG. 9 illustrates one embodiment of an transducer installation diagram in which transducers are installed on an annular ring outside the tank wall and on a tank floor inside a tank wall.

FIG. 10A illustrates one embodiment of the guided wave CT concept.

FIG. 10B illustrates a signal transmitted between a first sensor and a second sensor of FIG. 9A.

FIG. 10C illustrates a signal transmitted between a first sensor and a third sensor of FIG. 9A.

FIG. 11A illustrates four simulated corrosion damage states introduced at one location.

FIG. 11B illustrates one embodiment of an example transducer location layout on a tank floor.

FIGS. 12A-12C illustrate embodiments of guided wave tomograms showing accurate location and defect severity as a result of increasingly severe simulated corrosion damage on a tank floor mockup.

FIG. 13 illustrates one embodiment of a guided wave tomogram result showing a damage indication at the correct location when the tank floor mockup is filled with water.

FIG. 14 illustrates one embodiment of a guided wave tomogram result showing a damage indication at the correct location when the tank floor mockup has sludge/sediment present.

FIGS. 15A-15B illustrate embodiments of temperature compensation results.

### DETAILED DESCRIPTION

This description of the exemplary embodiments is intended to be read in connection with the accompanying drawings, which are to be considered part of the entire written description.

Ultrasonic guided waves are one candidate for detecting and monitoring corrosion and are especially well-suited for large-scale plate-like structures such as a storage tank floor. Ultrasonic guided waves are formed from the constructive interference of ultrasonic bulk waves that have interacted with the boundaries of the structure in which they propagate. Guided waves are unique in the sense that they are capable of propagating for long distances compared to traditional ultrasonic waves and can be used to inspect hidden/inaccessible structures like a storage tank floor behind a wall. Unlike “spot-checking” with traditional ultrasonic techniques, guided waves can provide up to a 100% volumetric inspection. Furthermore, guided waves provide an efficient and cost-effective means of inspection due to increased inspection speed and penetration power.

Inspecting large areas of a structure, such as a storage tank floor, with guided waves generally requires physically scanning one or more sending or receiving transducers around the structure or utilizing an array of fixed transducers in conjunction with a multiplexer system to gather guided wave data across a number of wave propagation paths throughout the structure. Examples of movable transducers for partial inspection of a storage tank floor include any one of a variety of piezoelectric, EMAT, or magnetostrictive sensors. It has been shown that by using computed tomography (CT) imaging techniques, such as the RAPID algorithm, in combination with guided wave activation and reception, it is possible to accurately detect and locate corrosion and cracking in plate and pipe structures using a small number of sensors to interrogate relatively large areas. In some guided wave tomography techniques, no baseline data set is required.

Storage tanks, pressure vessels, ship hulls, and other complex-plate structures are generally quite large and have a high degree of structural complexity including a multitude of plates joined through butt welds or lap welds, stiffeners, access ports, rivets, stringers and other miscellaneous affixed structures. These factors make guided wave inspection of such structures particularly challenging. The large size of the structures leads to a high degree of signal attenuation and beam spreading which limits the penetration power of the inspection. Structures that may be considered large for the purposes of this description are those with dimensions equal to or greater than approximately 20 feet. However, depending on the materials, complexity, and other dimensions of the structure, the inspection challenges that are associated with large-scale, complex structures may arise in structures with dimensions less than 20 feet. The structural and geometric complexity of these structures also leads to wave scattering, attenuation, mode conversion, and a multitude of other complicating factors that can make many guided wave inspection techniques impractical. Additionally, these structures are often in direct contact with fluids, which can lead to additional signal attenuation and distortion during guided wave inspection. The system and method described herein utilizes specially-selected parameters, including actuator/sensor design, guided wave mode and frequency choice, signal processing, and signal feature selection, to overcome these challenges which have heretofore hindered the utilization of guided wave and other structural health monitoring techniques on such large, complex structures.

For example, the size of a storage tank can be 300 feet in diameter or even larger. To monitor the tank floor condition with ultrasonic guided waves, ultrasonic transducers that can generate/receive guided waves in the tank floor with sufficient penetration distances are required, such that the entire tank floor or significant portions thereof can be monitored by transducers mounted on the annular ring outside the tank and possibly a small number of transducers mounted inside the tank.

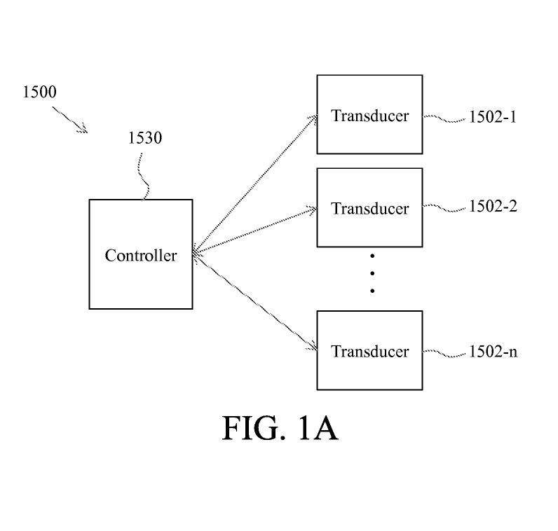

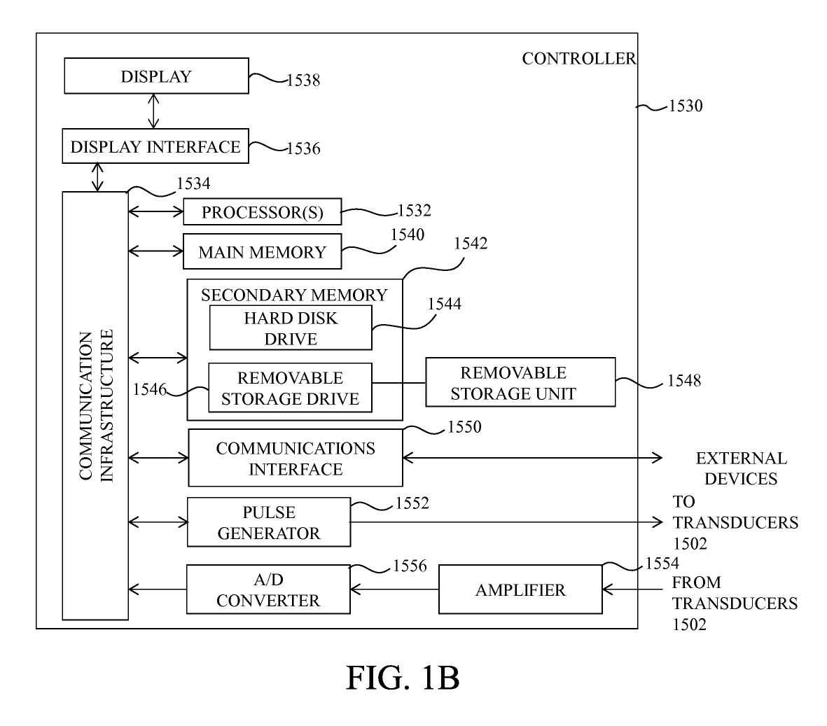

FIGS. 1A-1B illustrate one example of a non-destructive inspection system 1500 configured to inspect plates and plate-like structures using guided wave arrays according to the embodiments disclosed herein. As shown in FIG. 1A, inspection system 1500 includes a number, n, of transducers 1502-1, 1502-2, . . . , 1502-n (collectively “transducers 1502”) communicatively coupled to a controller 1530. In some embodiments, system 1500 is a “fixed” system in which the transducers are secured in some manner to a plate or plate-like structure. These transducers 1502 can be piezoelectric stack transducers, shear piezoelectric transducers, electromagnetic acoustic transducers (“EMATs”), magnetostrictive transducers, or other suitable transducers as will be understood by one of ordinary skill in the art. Transducers 1502 can be configured as a transmitter or a receiver in a through-transmission setup. Each of the transducers 1502 can also be used as a dual mode transducer under a pulse-echo test mode.

Referring now to FIG. 1B, controller 1530 is disclosed. The controller 1530 is configured to be coupled to the plurality of transducers 1502. The controller 1530 includes one or more processors, such as processor(s) 1532. Processor(s) 1532 may be any central processing unit (“CPU”), microprocessor, micro-controller, or computational device or circuit for executing instructions and be connected to a communication infrastructure 1534 (e.g., a communications bus, cross-over bar, or network). Various software embodiments are described in terms of this exemplary controller 1530. After reading this description, it will be apparent to one of ordinary skill in the art how to implement the method using other computer systems or architectures.

In some embodiments, controller 1530 includes a display interface 1536 that forwards graphics, text, and other data from the communication infrastructure 1534 (or from a frame buffer not shown) for display on a monitor or display unit 1538 that is integrated with or separate from controller 1530.

Controller 1530 also includes a main memory 1540, such as a random access memory (“RAM”), and a secondary memory 1542. In some embodiments, secondary memory 1542 includes a persistent memory such as, for example, a hard disk drive 1544 and/or removable storage drive 1546, representing an optical disk drive such as, for example, a DVD drive, a Blu-ray disc drive, or the like. In some embodiments, removable storage drive may be an interface for reading data from and writing data to a removable storage unit 1548. Removable storage drive 1546 reads from and/or writes to a removable storage unit 1548 in a manner that is understood by one of ordinary skill in the art. Removable storage unit 1548 represents an optical disc, a removable memory chip (such as an erasable programmable read only memory (“EPROM”), Flash memory, or the like), or a programmable read only memory (“PROM”)) and associated socket, which may be read by and written to by removable storage drive 1546. As will be understood by one of ordinary skill in the art, the removable storage unit 1548 may include a non-transient machine readable storage medium having stored therein computer software and/or data.

Controller 1530 may also include one or more communication interface(s) 1550, which allows software and data to be transferred between controller 1530 and external devices such as, for example, transducers 1502 and optionally to a mainframe, a server, or other device. Examples of the one or more communication interface(s) 1550 may include, but are not limited to, a modem, a network interface (such as an Ethernet card or wireless card), a communications port, a Personal Computer Memory Card International Association (“PCMCIA”) slot and card, one or more Personal Component Interconnect (“PCI”) Express slot and cards, or any combination thereof. Software and data transferred via communications interface 1550 are in the form of signals, which may be electronic, electromagnetic, optical, or other signals capable of being received by communications interface 1550. These signals are provided to communications interface(s) 1550 via a communications path or channel. The channel may be implemented using wire or cable, fiber optics, a telephone line, a cellular link, a radio frequency (“RF”) link, or other communication channels.

In this document, the terms “computer program medium” and “non-transient machine readable medium” refer to media such as removable storage units 1548 or a hard disk installed in hard disk drive 1544. These computer program products provide software to controller 1530. Computer programs (also referred to as “computer control logic”) may be stored in main memory 1540 and/or secondary memory 1542. Computer programs may also be received via communications interface(s) 1550. Such computer programs, when executed by a processor(s) 1532, enable the controller 1530 to perform the features of the method discussed herein.

In an embodiment where the method is implemented using software, the software may be stored in a computer program product and loaded into controller 1530 using removable storage drive 1546, hard drive 1544, or communications interface(s) 1550. The software, when executed by a processor(s) 1532, causes the processor(s) 1532 to perform the functions of the method described herein. In another embodiment, the method is implemented primarily in hardware using, for example, hardware components such as application specific integrated circuits (“ASICs”). Implementation of the hardware state machine so as to perform the functions described herein will be understood by persons skilled in the art. In yet another embodiment, the method is implemented using a combination of both hardware and software.

Controller 1530 also includes a pulse generator 1552 configured to output a variety of pulses to transducers 1502. For example, pulse generator 1552 may transmit time-delayed control signals to transducers 1502 and/or pulse generator 1552 may transmit control signals of varying amplitudes to transducers 1502.

An amplifier 1554 is configured to amplify signals received from transducers 1502. Such signals received by transducers 1502 include reflections of waves from structural features and other anomalies, e.g., corrosion in a plate or plate-like structures, in response to signals transmitted by pulse generator 1552. An analog to digital (“A/D”) converter 1556 is coupled to an output of amplifier 1554 and is configured to convert analog signals received from amplifier 1554 to digital signals. The digital signals output from A/D converter 1556 may be transmitted along communication infrastructure 1534 where they may undergo further signal processing by processor(s) 1532 as will be understood by one of ordinary skill in the art.

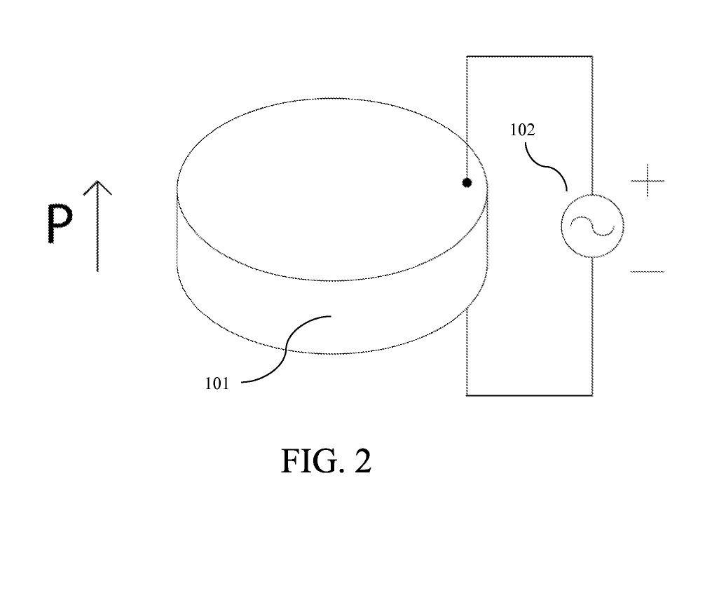

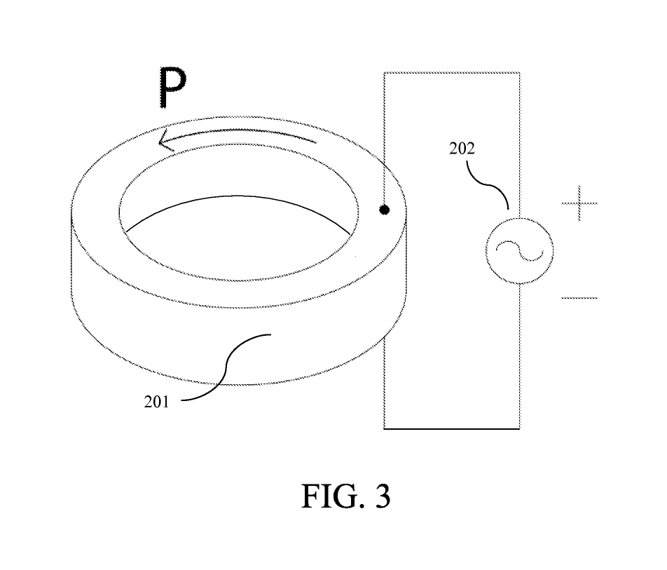

Both piezoelectric-type and magnetostrictive-type guided wave transducers may be used for tank floor monitoring. FIG. 2 and FIG. 3 illustrate two non-limiting examples of piezoelectric transducers 101 and 201 excited by AC sources 102 and 202, respectively. As shown in FIG. 2, piezoelectric disks 101 are poled in a thickness direction and may be used to generate and receive ultrasonic guided waves in tank bottoms in some embodiments. The diameter and thickness of the disks can be varied for different tank floors. For a given tank floor, analytical calculations, experimental methods and/or finite element simulations may be used to study the differences in guided wave excitations and receptions of piezoelectric disks with different thicknesses and diameters. This analysis is within the abilities of a person of ordinary skill in the art without undue experimentation. Optimal thickness and diameter combinations are identified that will be efficient in generating/receiving guided waves with good penetration distances in the tank floor. As a non-limiting example, 2″ to 3″ diameter piezoelectric disks with a 0.2″ or lower thickness may be pulsed at 100 kHz or lower frequencies to deform in their radial direction using the d₁₃ piezoelectric mode to efficiently excite guided waves in tank floors. As another non-limiting example, 1″ to 3″ diameter piezoelectric disks with a 0.5″ to 2″ thickness may be pulsed at 150 kHz or lower frequencies to deform in their thickness direction using the d₃₃ piezoelectric mode to efficiently excite guided waves in tank floors. Piezocomposite materials of the 1-3 form may also be substituted for homogeneous piezoelectric ceramic transducers and excited in the d₃₃ mode in some embodiments. Piezoelectric stack actuators, which are comprised by a stack of piezoelectric disks and operated in the d₃₃ mode may also be utilized in some embodiments.

In some embodiments, piezoelectric ring-type transducers 201, as shown in FIG. 3, are poled in the circumferential direction for guided wave structural monitoring of storage tank floors. When pulsed with one or more AC voltages 202, the circumferentially poled ring-type actuators can excite shear horizontal (SH)-type guided waves in tank floors using the d₁₅ piezoelectric mode. Compared to Lamb-type guided waves that can be excited by piezoelectric disk actuators 101, the SH waves are not sensitive to liquid loading conditions that are frequently encountered in tank floor monitoring applications. Additionally, the fundamental SH wave mode, the SH₀ mode, is non-dispersive in isotropic structures such as steel plates. Analytical calculations, numerical finite element simulations, and/or experimental tests can be used to determine the dimensions of the piezoelectric ring transducers 201 for different tank floor application, and are within the abilities of one skilled in the art.

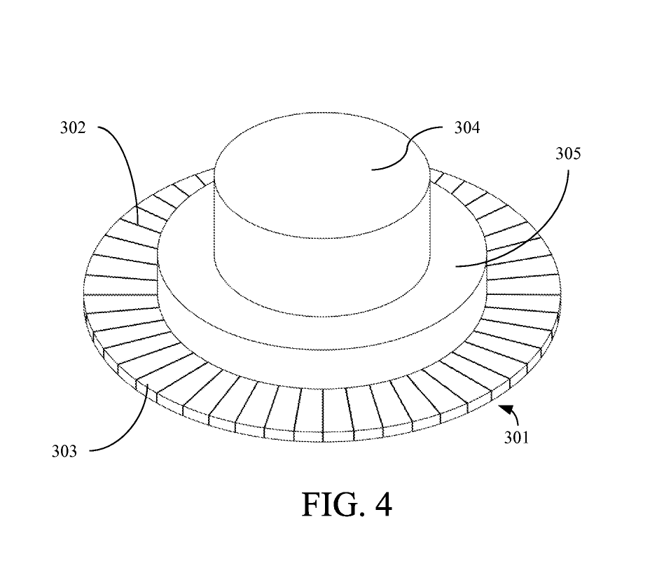

In another embodiment, a structure may be monitored using magnetostrictive SH-type transducers. A non-limiting example is shown in FIG. 4, in which a magnetostrictive SH-type transducer 301 contains a ring of magnetostrictive material 303 (such as, for example, iron, cobalt, Terfenol-D, Metglas 2605SC, or other magnetostrictive materials), current-carrying wires 302 wrapped around the magnetostrictive ring, a permanent magnet 304, and a layer of non-ferromagnetic material 305 placed in between the ring and the permanent magnet. A lift-off distance between the magnet and the magnetostrictive ring is controlled via the thickness of the non-ferromagnetic material. With an appropriate lift-off distance, the magnetic field of the permanent magnet is parallel or close to parallel to the horizontal surface at the ring of magnetostrictive material. Such a configuration will prompt SH guided wave excitation when passing AC current through the current-carrying wires 302. Similar to piezoelectric disks or rings 201, the magnetostrictive transducers 301 can serve as both actuators and receivers in some embodiments.

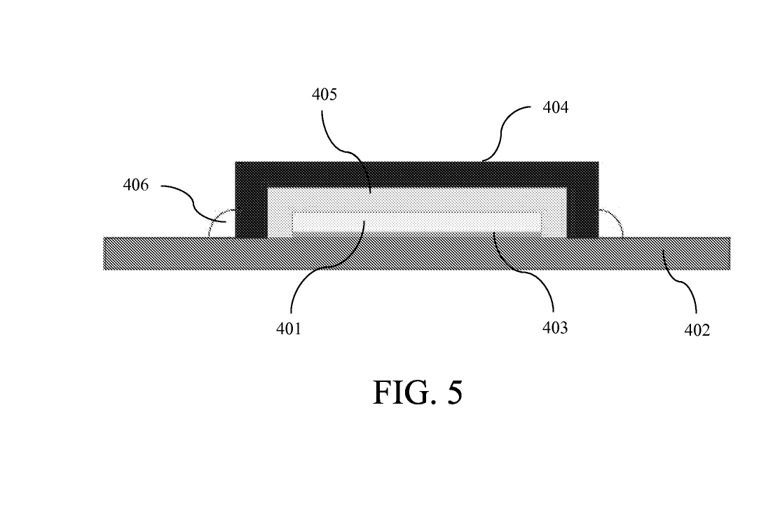

Transducer consistency and longevity is important for tank floor SHM applications. To protect the transducers from degradation due to exposure to environmental conditions or products stored in the storage tanks, it is necessary to pack the transducers inside environmentally sealed housings. FIG. 5 shows one embodiment of an transducer packaging scheme. In this example, the transducer 401 is attached to the tank floor 402 using epoxy 403. The transducer 401 is then covered by a corrosion-resistant housing 404. The edge of the housing is sealed to be watertight using sealant or gasket 406. In some embodiments, moisture absorbing materials or moisture impervious fill 405 may also be placed inside the housing.

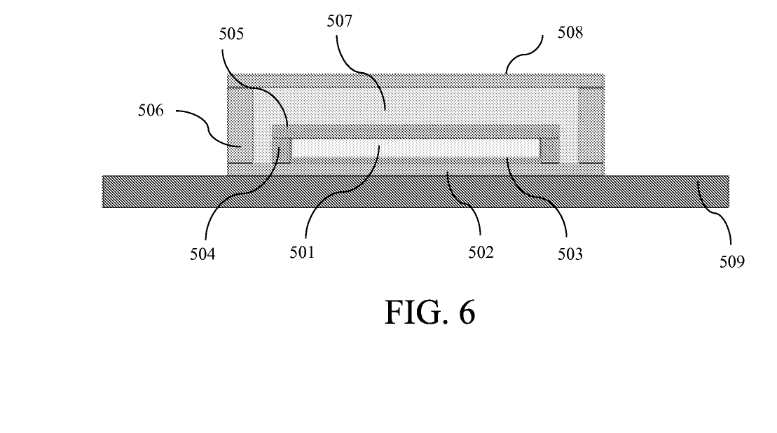

Another non-limiting embodiment of sensor packaging is illustrated in FIG. 6. In this embodiment, the transducer 501 is bonded to a faceplate 502 using epoxy 503 and encased in an environmentally-sealed housing 506 with a cap 508, which can be subsequently bonded to the tank floor 509. An isolation material 504 and 505, such as cork, and epoxy fill 507 can be used to fill and seal the housing and isolate the transducer.

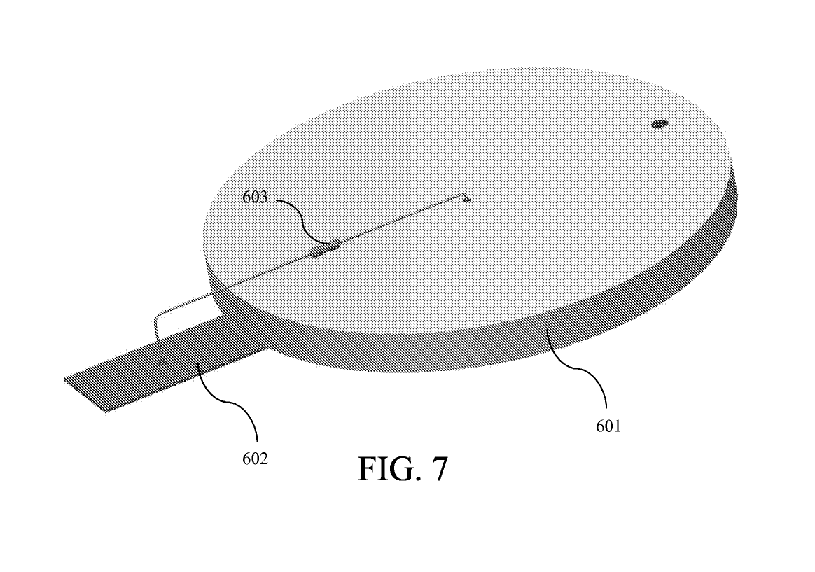

As illustrated in FIG. 7, if the piezoelectric transducer 601 does not have a wrapped-around ground electrode tab, a thin conductive strip 602, such as a strip of copper foil, can be bonded to the bottom of the piezoelectric disk or ring 601 using conductive or special non-conductive epoxy to serve as the ground electrode. A portion of the conductive strip 602 reaches out from underneath the transducer 601 for an easy ground connection. For a piezoelectric transducer 601, there could be static voltage accumulations due to thermal expansion or contraction of the piezoelectric material. While the transducer 601 is not connected to a closed circuit, the voltage accumulation can be significant. With the static voltage built-up in the piezoelectric material, when plugging the sensor into a data acquisition (DAQ) system, the discharge of the static voltage may damage the system. To prevent such damage, a resistor 603 is used to close the capacitive circuit formed by the parallel forces of the transducer 601. The resistor is connected between the ground and positive electrodes of the transducer. Any electrical charge due to the deformation of the piezoelectric material will then be discharged to the ground. The resistance value of the resistor is sufficiently high such that the excitation and reception of guided waves associated with AC voltages will not be significantly affected.

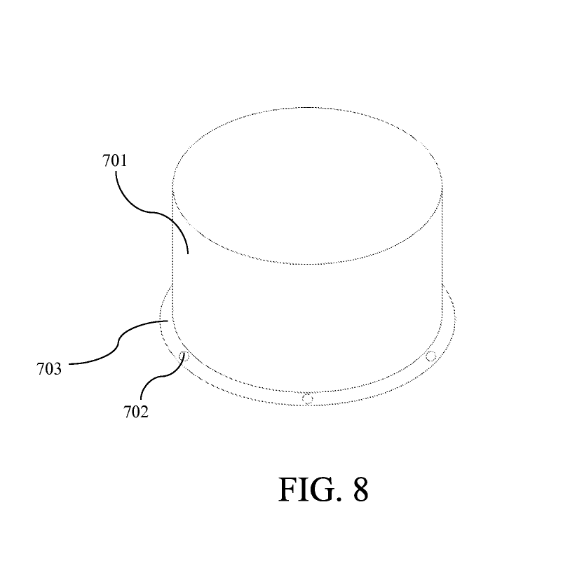

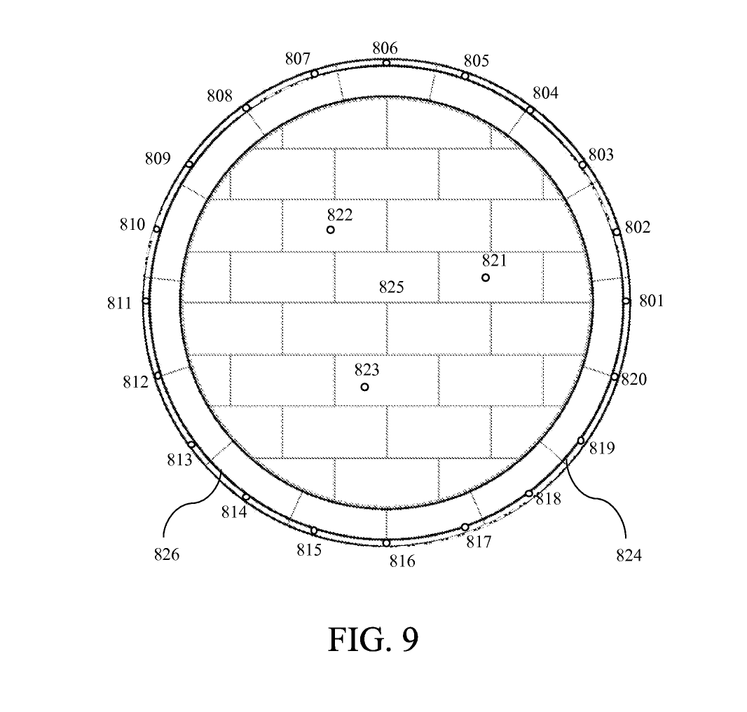

To monitor tank floors using ultrasonic guided waves, the guided wave transducers can be installed on an annular ring component of the tank floor that is outside the tank wall. For very large tanks, additional transducers may be installed inside the tanks to help achieve complete coverage of the tank floor. FIG. 8 provides an isometric view of a storage tank 701 with a series of transducers 702 attached to an annular ring 703. FIG. 9 provides a more detailed non-limiting transducer installation layout, in which a first set of transducers 801-820 are installed on an annular ring 824 outside of the tank wall 826 and a second set of transducers 821-823 are installed on the tank floor 825 inside the tank wall 826. The transducers 801-823 installed on the tank floor both inside and outside of the wall form an transducer network for guided wave tank floor monitoring.

The DAQ system for guided wave tank floor monitoring contains at least one pulser channel, one A/D channel, one multiplexer card, and a computer to control the hardware as well as to save and manage the guided wave signals. In some embodiments, a system with multiple pulser channels and A/D receiving channels to conduct simultaneous signal acquisitions may be used. Such a system may work with or without a multiplexer card.

At the beginning of the tank floor monitoring process, a set of baseline data are collected. The baseline data include guided wave through-transmission signals between all possible sensor pairs. For example, when using a 20 transducer network, one can first pulse transducer 1 and then receive guided wave signals from all other 19 transducers. After collecting collecting the 19 signals with transducer 1 pulsing, the pulsing channel can be switched to transducer 2 to collect another 19 signals with transducer 1 and transducers 3-20 as the receivers. The data collection process is continued until all transducers are pulsed as the transmitter once. As a result, a total of 19 by 20 signals will be collected.

In some cases, multiple actuators may be pulsed together with time delays to enhance guided wave penetration power. The time delays are calculated to focus the guided wave energy to a predefined location or to steer the guided wave energy into a predefined direction.

After the baseline data, subsequent data sets will be collected using the same setting as the baseline based on a defined data collection schedule or whenever the tank floor condition needs to be evaluated. The subsequent data sets will be compared with the baseline data to reveal possible tank floor condition changes.

Due to the large size of the tank floors, when collecting guided wave through-transmission signals using different transducer pairs, it is sometimes necessary to apply different gain values to the signals to suppress noise from analog-to-digital conversion. Using the transducer configuration in FIG. 9 as an example, when acquiring guided wave signals from two different transducer pairs, such as 801, 811 and 801, 803, the distances between the actuators and sensors are quite different. For a large tank floor size, the signal amplitude for the 801, 803 pair can be significantly higher than the amplitude for the 801, 811 pair, because of wave divergence and attenuation. If the same analog-to-digital conversion range is used for two signals with significantly different amplitudes, there will be high analog-to-digital conversion noise. To reduce such noise, it may be necessary to apply gain compensation during the signal collection process. For instance, a higher gain value can be used for the transducer pair 801, 811 than the 801, 803 pair such that the two signals have similar signal amplitudes.

In some embodiments, to calculate gain compensation values for different transducer pairs, a complete set of guided wave through-transmission signals is acquired from all possible transducer pairs. Based on the signal with the highest amplitude and the A/D card settings, an analog-to-digital conversion range can be selected such that the conversion range is sufficient for the A/D of the signal with the highest amplitude. A table of gain compensation values can then be calculated based on the comparisons of the maximum amplitudes of other signals with the highest amplitude, in which the gain compensation values are the logarithmic differences between the maximum amplitude of each signal compared with that of the highest amplitude signal. In other embodiments, gain compensation is achieved by cycling the system through each transducer pair and iteratively adjusting the gain until the maximum signal response within a predetermined time gate falls within a predetermined amplitude range with respect to the analog-to-digital voltage limits. This process is repeated for each transducer pair. After determining the gain compensation, the gain compensation table is saved in the DAQ system for further data acquisitions. When collecting new guided wave data, for a given transducer pair, the corresponding gain compensation value is read from the gain compensation table saved in the system and applied to the received signal before A/D conversion. By this approach, signals from different transducer pairs will have similar maximum amplitudes and therefore will yield lower analog-to-digital conversion noise.

In some embodiments, a CT image is generated by comparing changes in the guided wave signals that occur from damage being introduced into the structure, known as structural health monitoring (SHM). For example, a “feature value” is assigned to each signal associated with a sensor/actuator pair. This feature value may be calculated using a wide variety of methods which include, but are not limited to: time-domain features such as arrival time, wave packet width, maximum amplitude, wave packet skewness and kurtosis, signal difference coefficients, etc.; frequency-domain features such as peak frequency, frequency bandwidth, frequency ratios, energy ratios, etc.; time-frequency methods such as wavelet transforms, short-time Fourier transforms, etc.; and/or a combination of features generated via a neural network or other pattern recognition methods, etc., and/or any other combination of these methods.

In some embodiments a feature value calculation method that is sensitive to the critical types of defects for the structure while being less sensitive to non-critical environmental fluctuations is identified. The tomographic image is subsequently generated by compiling the feature value results for each transducer pair and assigning those values to weighted probability distributions in conjunction with the known locations of all transducers on the structure.

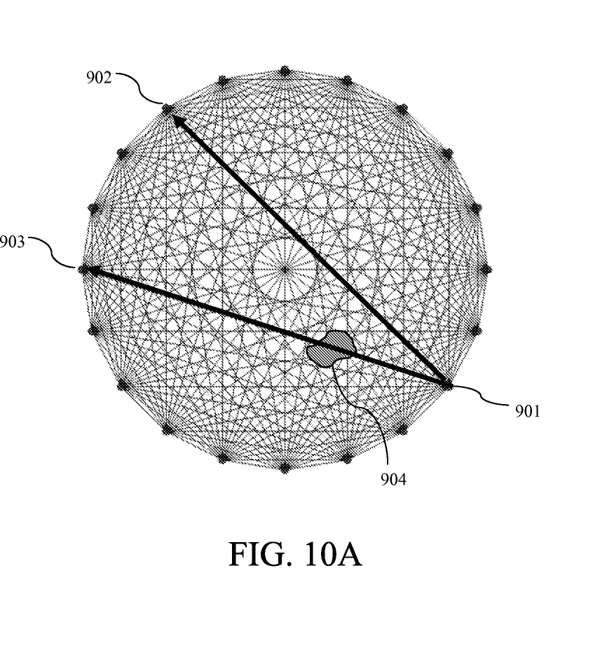

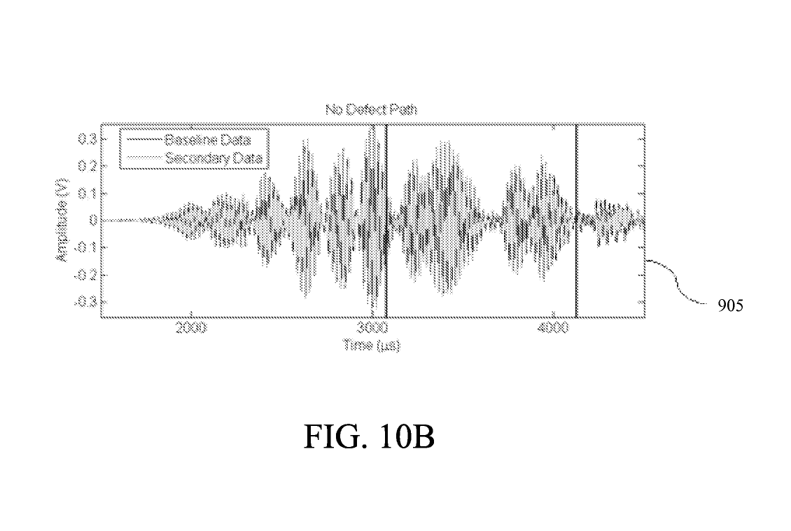

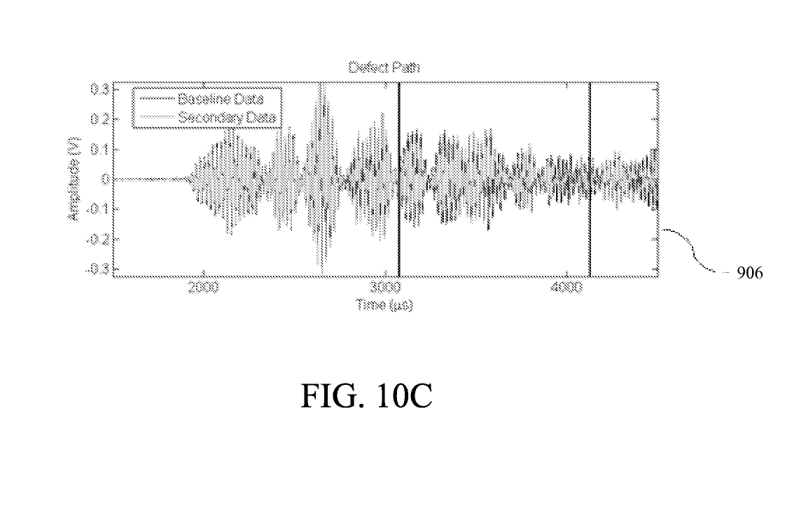

FIG. 10A shows an illustration of one embodiment of a guided wave computed tomography (CT) concept. All possible guided wave paths are shown for a 20-element guided wave transducer array. For SHM, baseline guided wave signals are collected for all wave paths. Subsequent data sets are acquired in the same manner over time. Guided wave signal variations can be observed when damage occurs in the area covered by the wave paths. The signal variations for different sensor pairs will be different. For example, sensor pair 901, 902 shown in FIG. 10A will produce consistent signals 905, as illustrated in FIG. 10B, before and after corrosion damage 904, because the corrosion damage 904 does not fall within the wave path between these two sensors. In contrast, sensor pair 901, 903 will produce significant signal variations 906, illustrated in FIG. 10C, before and after the corrosion because the damage 904 is located in the wave path between the sensor pair 901, 903. In some embodiments, the guided wave tank floor monitoring system contains guided wave CT algorithms that utilize the signal variations for different wave paths to reconstruct CT images that reveal the location, approximate size, and severity of possible damage to the structure under monitoring. The algorithms are applicable to sensor arrays with arbitrary sensor placements and also take into account guided wave beam divergence in plate-like structures.

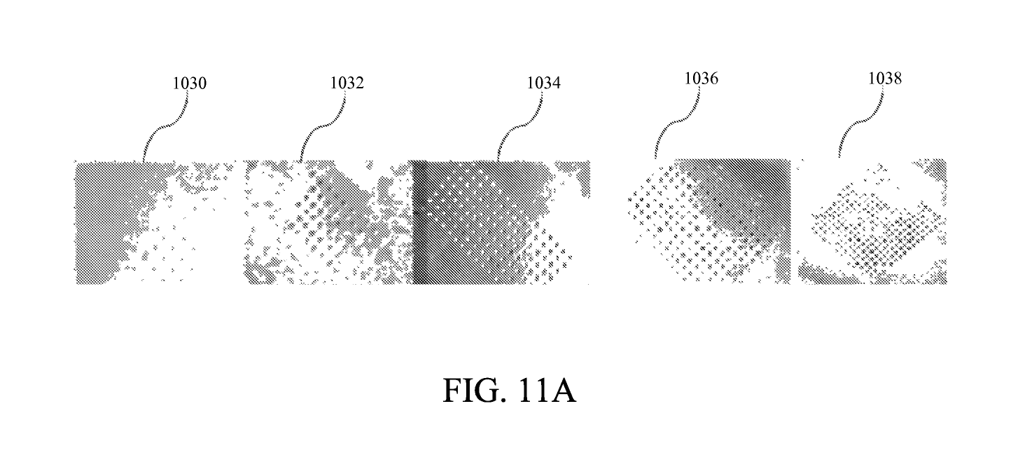

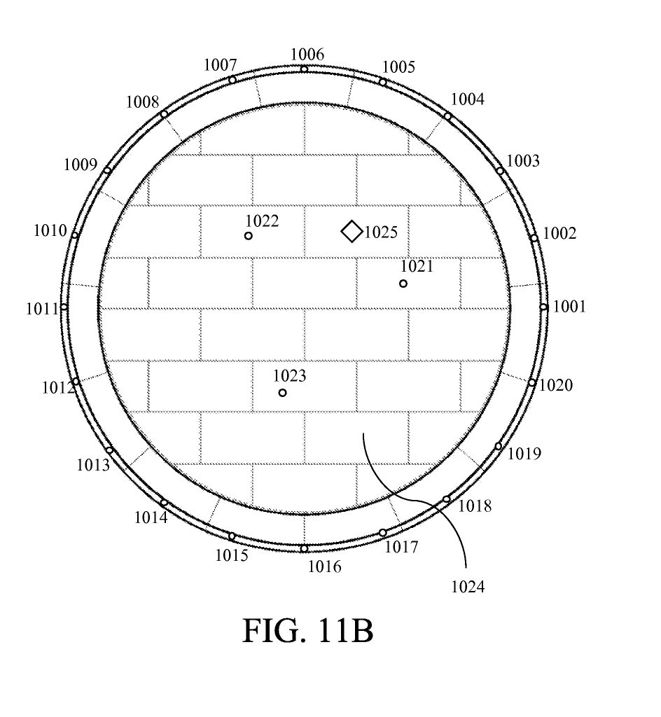

One non-limiting embodiment of the system is presented with sample results. In this example, experiments were carried out on a 36.5° diameter tank floor mockup to demonstrate the guided wave monitoring system. FIG. 11A illustrates four simulated corrosion damage states 1030-1038 sequentially introduced to one location of the tank floor mockup. FIG. 11B shows the geometry of the tank floor mockup 1024, the locations of the transducers 1001 through 1023 used for generating guided wave tomograms, and the location 1025 for the introduction of simulated corrosion damage 1030-1038 to the tank floor mockup. As shown, 20 piezoelectric disk transducers were used in the experiments. They were equally spaced around the annular ring outside the tank wall. The transducers were packaged based on the packing scheme shown in FIG. 5.

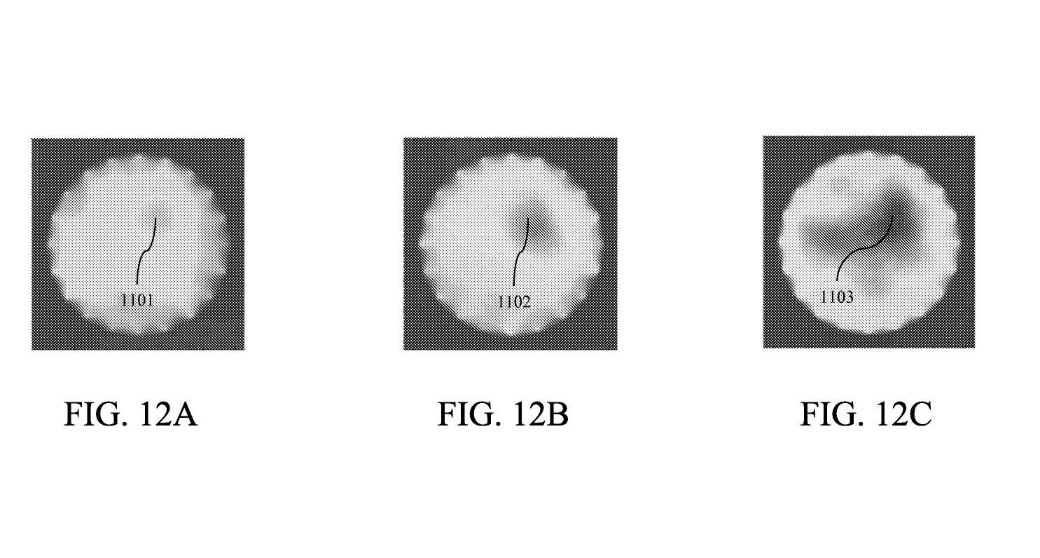

Baseline signals were collected before the simulated corrosion was introduced. Subsequent data sets were acquired after each corrosion growth step. FIGS. 12A-12C show example guided wave tomograms that were calculated using a frequency ratio feature. For each transducer pair, the frequency ratio feature was calculated from a section of the guided wave signal that was gated based on the distance of the direct wave path and the A₀ mode guided wave velocity. With a 45 kHz pulsing frequency, the energy ratio was defined as the ratio of the energy within the 40 kHz to 45 kHz frequency bandwidth and the energy within the 45 kHz to 50 kHz range. The variations of the energy ratio from baseline to the subsequent data sets were used as the inputs for the tomographic image reconstruction algorithm. As shown in FIGS. 12A-12C, indications 1101, 1102, and 1103 of the simulated corrosion damage 1030-1038 were found at the correct location. Additionally, for greater changes in the area of simulated corrosion 1030-1038, the severity of the indication is higher.

For different tank floor structures and/or different guided wave transducers, different guided wave features may be used to replace the energy ratio feature used in the example presented here. In some embodiments, different signal gating processes may be used to calculate guided wave features. The objective of the feature selection algorithm is to identify appropriate signal gates and guided wave features that are sensitive to damage to the tank floor but robust under other variations, such as environmental condition changes, pressure and amount of storage materials inside the tank, changes on the annular ring outside the tank wall, and/or other variations.

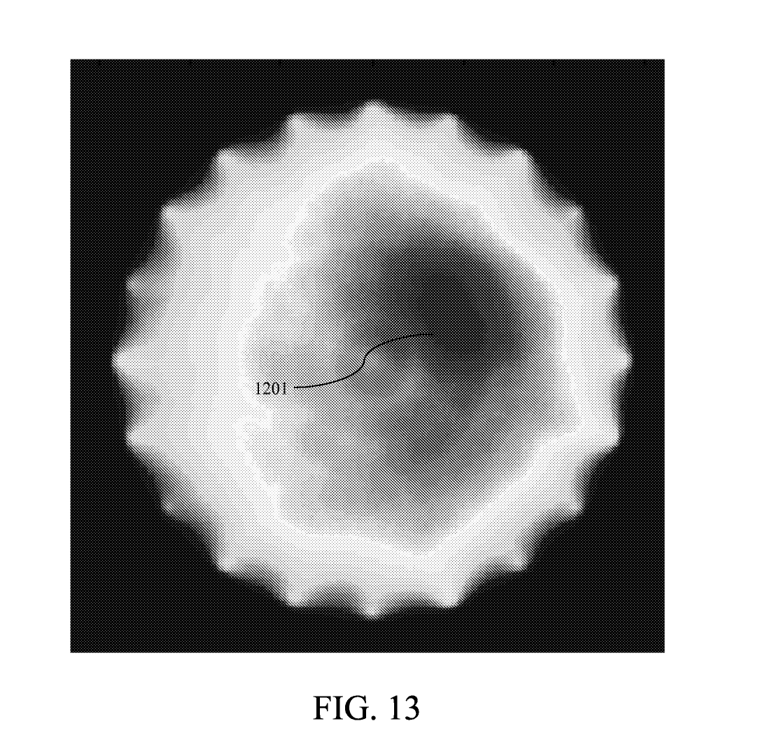

Large storage tanks are often used to store liquid materials. Experiments have been conducted on a water-loaded tank floor mockup to demonstrate the feasibility of using the disclosed guided wave system for monitoring tank floors with liquid materials inside the tanks. Baseline data for the water-filled condition was taken before the simulated corrosion damage was introduced to the tank floor. The tank floor mockup was filled with water at the time when the baseline data was collected. Another guided wave data set was taken at a similar water filled condition after the corrosion damage 1030-1038 shown in FIG. 11A was introduced. The same frequency ratio feature used for FIGS. 12A-12C was applied to generate a guided wave tomogram using the baseline and the subsequent data sets for the water filled condition. The result is shown in FIG. 13, in which it is demonstrated that a damage indication 1201 was found at the correct corrosion damage location even under the water loaded condition.

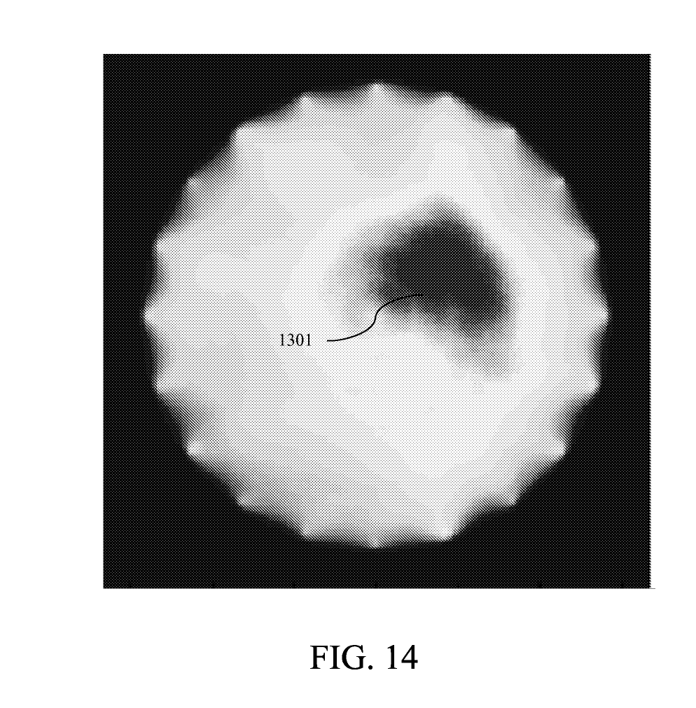

When using storage tanks for crude oil or some refinery products, deposits from the materials stored in the tanks may make the tank floor condition more complicated. It is necessary to make sure that the guided wave tank floor monitoring system can still function well when there are deposits such as oil sludge on the tank floor under monitoring. The sludge condition was simulated using wet sediment. The objective of the feasibility study was to demonstrate that the guided wave tank floor monitoring system could still detect and correctly locate corrosion damage when there is sludge on the tank floor. In one embodiment, guided wave data were collected with the sludge on the tank floor after corrosion damage (also see FIG. 11A). The guided wave tomogram is shown in FIG. 14. The tomogram was also calculated by comparing the frequency features for the new sludge condition data set to the baseline data set that was taken without the sludge condition. The damage indication 1301 for the corrosion is found at the correct location. Therefore the guided wave tank floor monitoring system can still detect and locate corrosion damage even when there is sludge deposited on the tank floor.

It is known that ultrasonic guided wave propagation can be affected by temperature changes. For structural health monitoring applications that involve comparisons between guided wave baseline data and subsequent data sets that may be collected at different temperatures, it is important to consider temperature effects on guided wave signals. In one embodiment, multiple baseline data sets are used to deal with temperature effects. At the beginning of a tank floor monitoring application, multiple baseline data sets can be collected at different temperatures. The baseline data sets are saved in the tank floor monitoring system together with the temperatures at which they are acquired. Whenever a subsequent data set is taken to evaluate the tank floor condition, the temperature is recorded and compared with the baseline temperatures. The new data set will be compared with one of the baseline data sets with a similar data collection temperature to generate guided wave tomograms. In some embodiments, a plurality of temperature measurements from various points on the structure will be recorded with each data set. An automated algorithm can be used to intelligently select the appropriate baseline data set for each subsequent measurement by comparing the temperature distribution profiles of the current and baseline sets to identify a best match.

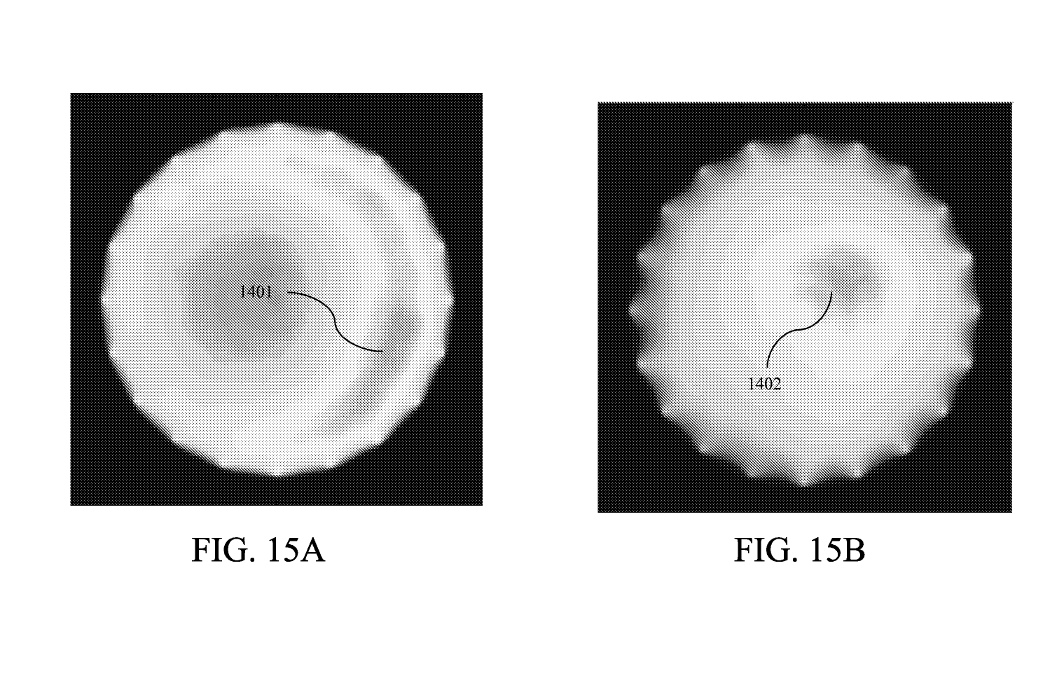

In another embodiment, temperature compensation algorithms are used to the guided wave signals to compensate for the signal variations due to temperature changes. A number of signal processing methods may be used to compensate the temperature influences, such as a signal stretch and shift method, a phase compensation method, etc. FIGS. 15A-15B show example temperature compensation results obtained with a phase compensation method. The phase compensation method compensates for the phase difference caused by guided wave velocity changes due to temperature influence. To compensate the phase difference from one guided wave signal s₁ to another signal s₀, acquired at a different temperature, the temperature compensation algorithm used for FIGS. 15A-15B first calculates the signal envelopes and instantaneous phases of the two signals using the Hilbert transform. A new signal s₁′ is then calculated by combining the signal envelope of s₁ with the instantaneous phases of s₂. The next step of the temperature compensation calculation is to shift the s₁′ signal in time until the cross correlation between the shifted s₁′ signal and s₀ reaches its maximum. The time shifted s₁′ signal is the temperature compensated signal. The guided wave tomograms shown in FIGS. 15A-15B were calculated for a 72.7 in² increase in corrosion area. FIG. 15A was calculated using two data sets taken at two different temperatures without temperature compensation. There was a 24° F. temperature difference for the temperatures measured at the center of the tank floor for the two data sets. A signal difference coefficient feature was used to generate the tomogram. As can be seen, due to the temperature influence, there were image artifacts 1401 in the tomogram that would produce false alarms in the tank floor monitoring application. To suppress the temperature influence, the data set that was taken before the corrosion area was increased was compensated using a set of baseline data that was taken at a similar temperature as the data set after the damage was increased. The temperature compensated data were then compared with the data for the larger corrosion area to generate the tomogram. FIG. 15B illustrates that a correct damage indication 1402 was obtained. In other embodiments, variations of temperatures and environmental conditions can be applied.

Complex, multi-plate, multi-weld structures, such as storage tank floors, cannot easily and quickly be inspected with most nondestructive inspection techniques including ultrasonic guided wave inspection methods. In fact, due to the structural complexity, nondestructive inspection of storage tank floors without emptying the tanks is often not possible. However, a structural health monitoring (SHM) approach allows collection of a baseline for which later comparisons with new data can indicate damage growth. With appropriate ultrasonic guided wave transducer selections, a DAQ system suitable for collecting guided wave signals from a multiple transducer network, appropriate signal processing, and image reconstruction algorithms, it becomes possible to monitor complex, multi-plate, multi-weld structures, such as storage tank floors, for damage growth.

What is claimed is:

1. A system, the system comprising:
a plurality of transducers configured to be coupled to a periphery of a complex-plate structure; and
a controller electrically coupled to the plurality of transducers, the controller including:
a machine readable storage medium; and
a processor in signal communication with the machine readable storage medium, the processor configured to:
generate a plurality of guided wave signals using a first set of the plurality of transducers;
receive the plurality of guided wave signals at a second set of the plurality of transducers; and
generate tomographic pseudo-image of structural changes of the complex-plate structure based on the plurality of guided wave signals received at the second set of the plurality of transducers.

2. The system of claim 1, wherein the plurality of transducers comprises a plurality of ultrasonic transducers.

3. The system of claim 2, wherein the controller comprises at least one actuation channel, at least one analog-to-digital converter channel, and at least one multiplexer card, and wherein the controller is configured to control the plurality of ultrasonic transducers for data acquisition, data processing, and data management.

4. The system of claim 2, wherein the plurality of ultrasonic transducers comprise piezoelectric transducers.

5. The system of claim 4, wherein each of the plurality of piezoelectric transducers comprises a piezoelectric disk that is poled in a thickness direction and operated in one of a radial vibration mode utilizing a d₁₃ piezoelectric coefficient to generate Lamb-type guided wave modes or a thickness vibration mode utilizing a d₃₃ piezoelectric coefficient to generate Lamb-type guided wave modes.

6. The system of claim 4, wherein the plurality of piezoelectric transducers comprises 1-3 type piezocomposite materials that are poled in a thickness direction and operated in a thickness vibration utilizing the d₃₃ piezoelectric coefficient to generate Lamb-type guided wave modes.

7. The system of claim 4, wherein the plurality of piezoelectric transducers comprise piezoelectric rings that are poled circumferentially and operated in a torsion mode utilizing a d₁₅ piezoelectric coefficient to generate shear horizontal-type guided wave modes.

8. The system of claim 4, wherein the piezoelectric transducers are composed of a plurality of concentric annular piezoelectric elements configured to selectively generate and receive predetermined guided wave modes.

9. The system of claim 1, wherein the plurality of transducers comprise magnetostrictive transducers.

10. The system of claim 9, wherein the magnetostrictive transducers comprise a printed circuit board and one or more permanent magnets to generate SH-type guided waves.

11. The system of claim 10, wherein the printed circuit board comprises one of a flexible or a rigid printed circuit board.

12. The system of claim 9, wherein each of the magnetostrictive transducers comprise a wound wire coil and one or more permanent magnets to generate SH-type guided waves.

13. The system of claim 1, comprising a plurality of impact actuators configured to generate broadband-frequency guided wave energy into the storage tank.

14. The system of claim 1, wherein the plurality of transducers are arranged on an annular section of the floor of the plate-like structure, wherein the annular section is located outside of a side wall of the plate-like structure.

15. The system of claim 1, wherein the plurality of transducers are arranged on at least one of:
an interior of the plate-like structure; and
a radial edge of the floor plate.

16. The system of claim 15, wherein the plurality of transducers are applied in pairs opposite one another on an upper and a lower surface of the floor plate and operated in one of an in-phase mode configured to predominantly generate symmetric-type guided wave modes or an anti-phase mode configured to predominantly generate antisymmetric-type guided wave modes.

17. The system of claim 1, wherein a frequency of the guided waves is less than about 200 kHz.

18. A method, comprising:
generating at least one set of baseline signals representative of a storage structure in an initial state;
transmitting a plurality of guided wave signals through one or more surfaces of the storage structure, wherein the plurality of guided wave signals are generated by a plurality of transducers;
receiving the plurality of guided wave signals, wherein the plurality of guided wave signals are received by the plurality of transducers;
generating a tomographic pseudo-image of one or more structural changes by processing and comparing the plurality of received guided wave signals to the at least one set of baseline signals.

19. The method of claim 18, wherein the plurality of guided wave signals is transmitted by a first set of the plurality of transducers, and wherein the plurality of guided wave signals is received by a second set of the plurality of transducers.

20. The method of claim 18, wherein two or more of the plurality of transducers are pulsed together with predetermined time delays to focus guided wave energy at predetermined locations to enhance guided wave penetration power.

21. The method of claim 18, wherein generating the tomographic pseudo-image comprises applying a gain compensation algorithm to compensate for signal amplitude variations.

22. The method of claim 18, further comprising, prior to transmitting the plurality of guided waves, calibrating the plurality of transducers, wherein calibrating the plurality of transducers comprises:
actuating each of the plurality of transducers in a pulse-echo mode; and
analyzing a near-field response of the pulse-echo mode by comparing a pulse-echo signal to one or more baseline data sets.

23. The method of claim 18, wherein generating the tomographic pseudo-image comprises applying a tomographic reconstruction algorithm that accounts for guided wave beam divergence and scattering, wherein the tomographic reconstruction algorithm utilizes a known geometric arrangement of the plurality of transducers and at least two sets of generated guided wave signals.

24. The method of claim 23, further comprising:
calculating one or more signal features from the at least two sets of guided wave signals; and
utilizing the one or more signal features in the tomographic reconstruction algorithm to assign a weighting value to individual ray paths associated with individual sensor pairs.

25. The method of claim 24, wherein the one or more signal features comprise at least one of:
a time-based feature comprising at least one of a signal difference coefficient, a velocity measurement, an energy measurement, and an attenuation measurements;
a frequency-based feature comprising at least one of a frequency spectrum distribution or a peak frequency;
a time-frequency feature comprising at least one of a short-time Fourier transform or a wavelet transform;
a ratio-based feature comprising at least one of an amplitude ratio of one or more guided wave modes or energy ratios between one or more frequency bands, or any combination thereof.

26. The method of claim 24, further comprising selecting the one or more signal features to maximize sensitivity to one or more particular forms of damage and to minimize sensitivity to environmental variables.

27. The method of claim 24, wherein the one or more signal features are calculated over one or more predetermined gated portions of the signals.

28. The method of claim 24, wherein a set of the one or more signal features is combined to yield an additional signal feature using at least one of:
pattern recognition,
a neural network, and
statistical analysis.

29. The method of claim 18, further comprising applying a temperature compensation algorithm to minimize sensitivity to changes in a temperature of the storage structure.

30. The method of claim 18, further comprising inspecting partitioned regions of the storage structure by utilizing one or more sets of the plurality of transducers.

31. A system, comprising:
a plurality of transducers configured to be coupled to a periphery of a complex-plate structure; and
a controller electrically coupled to the plurality of transducers, the controller including:
a machine readable storage medium; and
a processor in signal communication with the machine readable storage medium, the processor configured to:
generate a plurality of guided wave signals using a first set of the plurality of transducers;
receive the plurality of guided wave signals at a second set of the plurality of transducers; and
generate tomographic pseudo-image of structural changes of the complex-plate structure based on the plurality of guided wave signals received at the second set of the plurality of transducers, wherein the system is adapted to optimize at least one of a transducer design, a guided-wave mode, a signal strength, a signal frequency, signal processing, or one or more signal features for the complex-plate structure.
